(19) United States
(12) Patent Application Publication
(10) Pub. No.: US 2013/0174020 A1
(43) Pub. Date: Jul. 4, 2013

(54) INFORMATION ADDING METHOD AND INFORMATION PROCESSING APPARATUS

(71) Applicant: FUJITSU LIMITED, Kawasaki-shi (JP)

(72) Inventors: Torrey MARTIN, Zushi (JP); Keiji Miyauchi, Yokohama (JP)

(73) Assignee: FUJITSU LIMITED, Kawasaki-shi (JP)

(21) Appl. No.: 13/778,490

(22) Filed: Feb. 27, 2013

Related U.S. Application Data
(63) Continuation of application No. PCT/JP2010/066846, filed on Sep. 28, 2010.

(51) Int. Cl. G06F 17/22

(52) U.S. Cl. CPC G06F 17/2247
USPC 715/234

(57) ABSTRACT

An apparatus may store, into a file of a storage unit, position information indicating a position on a Web page that is being displayed on a screen of a display unit and specified from an input device, and input information to be added with respect to the position and input from the input device, with respect to the Web page. The apparatus may display the input information stored in the file on the screen in a vicinity of the position when a cursor on the screen of the display unit displaying the Web page enters a predetermined range from the position indicated by the position information.

### CROSS-REFERENCE TO RELATED APPLICATIONS

This application is a continuation application of International Application No. PCT/JP2010/066846 filed on Sep. 28, 2010 and designated the U.S., the entire contents of which are incorporated herein by reference.

### FIELD

The embodiments discussed herein are related to an information adding method, an information processing apparatus, and a computer-readable storage medium having stored therein a program for causing a computer to execute a process for adding information, in a referable manner, with respect to contents of a browsing Web page.

### BACKGROUND

When a user browses a Web page on the Internet using a Web browser, the user may wish to record information, such as comments, with respect to contents of the Web page.

According to a first conventional method, the comments may be recorded in correspondence with a URL (Uniform Resource Locator) of the Web page. The comments may be added in a booklist of the browser, for example. However, it may be difficult to know the particular contents of the Web page to which the comments are intended. In addition, the URL of the Web page and the comments that are recorded in correspondence with the URL need to be read every time the user wishes to refer to the comments.

On the other hand, according to a second conventional method, a portion of the Web page may be copied by a screen capture tool, and comments may be added with respect to the copied portion. In this case, it may be possible to know the particular contents of the Web page to which the comments are intended, because the comments are added with respect to the copied portion of the Web page. However, the troublesome operation of copying the portion of the Web page needs to be performed by the user, and a relatively large storage capacity may be required to store the copied portion of the Web page. In addition, the copied portion of the Web page and the comments that are recorded in correspondence with the copied portion need to be read every time the user wishes to refer to the comments. Further, when the copied portion of the Web page and the comments are stored at an external Web site, security measures may be required in order to secure security of the stored information. However, it may be difficult to secure the security of the stored information when an access to the external Web site is required every time the user wishes to refer to the comments recorded in correspondence with the copied portion of the Web page.

According to a third conventional method, a source of the Web page may be stored, and the comments may be added by editing HTML (Hyper Text Markup Language) codes of the stored source. In this case, the editing of the HTML codes need to be performed by the user, and thus, the user may require knowledge of the HTML codes.

According to the first through third conventional methods described above, even when the user browses the Web page to which the user added comments in the past, the user is unable to know, from the Web page, the comments added in the past. In other words, the user may search for information managed in a separate file, for example, using the URL and the like of the Web page, and refer to the comments in the separate file if any. However, in this case, efficient utilization of the comments by the user may be difficult.

A designing system may add comments with respect to items (or objects) having a predetermined attribute displayed on a screen. A Japanese Laid-Open Patent Publication No. 2009-225082 proposes an example of such a designing system. However, according to the proposed designing system, the attributes of the objects to which the comments may be added are determined in advance, and a degree of freedom with which the comments may be added to the objects may be relatively low. In addition, because the comments are stored together with position information of the object on the screen by confirming the attribute of the object, information indicating the attribute need to be included in information related to the object. Furthermore, because the comments may be added in a description language depending on the attribute of the object, a degree of freedom with which the description language may be selected for the comments may be relatively low.

Therefore, in the prior art, it may be difficult to add input information, such as comments, with respect to a portion of the Web page by a relatively simple operation, in a description language that does not depend on the description language of the Web page, when browsing the Web page.

### SUMMARY

Accordingly, it is an object in one aspect of the embodiment to provide an information adding method, an information processing apparatus, and a computer-readable storage medium, which may add input information with respect to a portion of the Web page by a relatively simple operation, in a description language that does not depend on the description language of the Web page, when browsing the Web page.

According to one aspect of the present invention, an information processing apparatus may include a display unit configured to display on a screen thereof a Web page that is being browed; an input device configured to receive position information indicating a specified position on the Web page, and input of input information to be added with respect to the position; a storage unit configured to store the position information and the input information in a file with respect to the Web page; and a control unit configured to display the input information stored in the file on the screen in a vicinity of the specified position when a cursor on the screen of the display unit displaying the Web page enters a predetermined range from the specified position indicated by the position information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a structure of a computer system in one embodiment;

FIG. 2 is a flow chart for explaining an example of procedures of an information adding process;

FIGS. 3A and 3B are diagrams for explaining an example of a Web page;

FIG. 4 is a diagram for explaining range information;

FIG. 5 is a diagram for explaining a setting of the range information;

FIG. 6 is a diagram for explaining an example of information stored in a local file;

FIG. 7 is a flow chart for explaining an example of procedures of a setting process;

FIG. 8 is a diagram illustrating an example of selection buttons;

FIG. 9 is a diagram for explaining an icon map process;

FIG. 10 is a flow chart for explaining an input information display process;

FIG. 11 is a diagram for explaining an example of a popup display;

FIG. 12 is a flow chart illustrating an example of the information adding process including user operations;

FIG. 13 is a flow chart illustrating the example of the information adding process including the user operations;

FIG. 14 is a flow chart for explaining an example of an input information adding process including translation;

FIG. 15 is a diagram illustrating an example of the Web page;

FIGS. 16A and 16B are diagrams for explaining an example of information stored in the local file;

FIG. 17 is a diagram for explaining an example of the popup display;

FIG. 18 is a flow chart for explaining an example of the input information adding process including links;

FIG. 19 is a diagram illustrating an example of the Web page;

FIG. 20 is a diagram for explaining an example of information stored in the local file;

FIG. 21 is a diagram for explaining an example of the popup display;

FIG. 22 is a flow chart for explaining an example of the input information adding process that permits sharing of the local file;

FIG. 23 is a diagram illustrating an example of the Web page; and

FIG. 24 is a diagram for explaining an example of a window display.

### DESCRIPTION OF EMBODIMENTS

Preferred embodiments of the present invention will be described with reference to the accompanying drawings.

A description will now be given of the information adding method, the information processing apparatus, and the computer-readable storage medium in each embodiment according to the present invention.

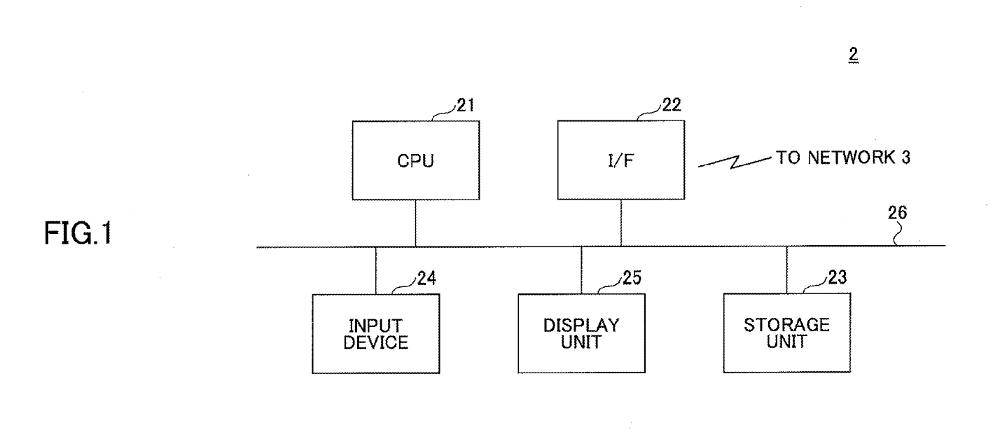

FIG. 1 is a block diagram illustrating an example of a structure of a computer system in one embodiment. In FIG. 1, a computer system 2 may include a CPU (Central Processing Unit) 21, an interface (I/F) unit 22, a storage unit 23, an input device 24 including a keyboard, a mouse and the like, and a display unit 25 that may be connected via a bus 26. As will be described later, a user may operate the input device 24 to specify a position on a Web page that is being displayed on a screen of the display init 25 and browsed, in order to input, to the CPU 21, position information of specified position from the input device 24. In addition, the user may operate the input device 24 to input, to the CPU 21, input information such as comments to be added with respect to the specified position from the input device 24. For example, the position on the Web page may be specified by a hot key operation of the keyboard, a click operation of the mouse, and the like. On the other hand, the input information to be added may be input by a key operation of the keyboard, a copy-and-paste operation by at least one of the keyboard and the mouse, and the like.

The CPU 21 may control the entire computer system 2, and also realize a browser function, an information adding function, and the like by executing various programs including a browser program, an information adding program, and the like. The I/F unit 22 may include a function to output commands (or requests) and data sent from the computer system 2 to a network 3, and to input commands and data received from the network 3 to the computer system 2. The storage unit 23 may store various programs including the browser program and the information adding program to be executed by the CPU 21, various data including intermediate data of computations or operations executed by the CPU 21, and the like. The storage unit 23 may be divided into a first storage unit to store the various programs, and a second storage unit to store the various data and the like. The input device 24 may be used to input various commands and data to the CPU 21. The display unit 25 may be used to display screens urging the user to make an operation, such as an information adding screen, Web sites that are accessed, results of operation or computations executed by the CPU 21, and the like.

The storage unit 23 may be formed by a non-transitory computer-readable storage medium. Examples of the non-transitory computer-readable storage medium may include a magnetic recording medium, an optical recording medium, a magneto-optic recording medium, a disk unit using a disk as a recording medium, a semiconductor memory device such as a ROM (Read Only Memory), and the like. The browser program and the information adding program may be stored in the non-transitory computer-readable storage medium. However, the information adding program may form a part of the browser program. In addition, the information adding program may form a plug-in that is separate from the browser program.

The computer system 2 may be formed by general-purpose computer, such as a PC (Personal Computer), for example. The computer system 2 may be a desktop type computer or a portable (or laptop) type computer. In addition, hardware structure of the computer system 2 is not limited to the structure illustrated in FIG. 1, and various other known structures may be employed instead. Further, the disclosed information processing apparatus is not limited to the computer system, and may include various electronic apparatuses having the browser function, such as a cell (or cellular) phone, a mobile terminal, and the like.

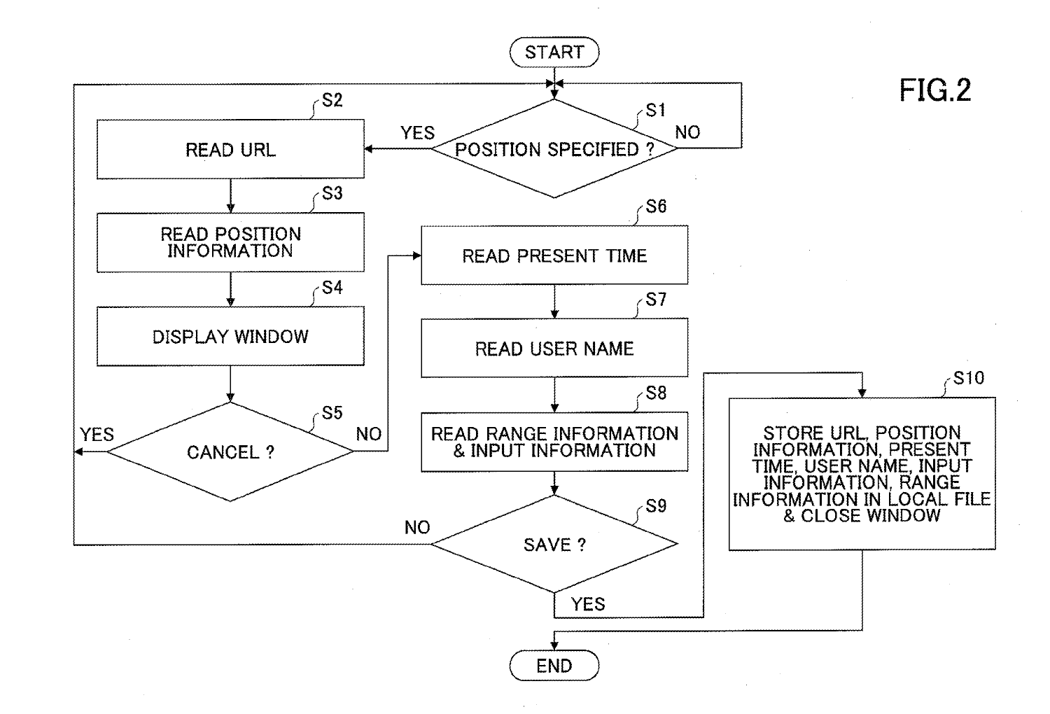

FIG. 2 is a flow chart for explaining an example of procedures of an information adding process that adds the input information by specifying a position on the Web page that is displayed on the screen of the display unit 25. The process illustrated in FIG. 2 may be executed by the CPU 21. It is assumed for the sake of convenience that the information adding process illustrated in FIG. 2 is started in a state in which a Web page is already displayed on the screen of the display unit 25, which Web page is accessed using a known browser function when the CPU 21 executes the browser program in response to an operation made by the user from the input device 24. It is also assumed for the sake of convenience that information related to the type of browser program is already notified to the CPU 21 by a known method.

In FIG. 2, step S1 decides whether the user performed a position specifying operation from the input device 24. The process advances to step S2 when the decision result in step S1 is YES. For example, the position specifying operation may be the hot key operation. Step S2 reads the URL of the Web page that is being displayed on the screen of the display unit 25. Step S3 reads position information indicating a position (hereinafter also referred to as a “cursor position”) that is pointed by a cursor that is displayed on the screen of the display unit 25. Because the CPU 21 is notified of the information related to the type of browser by the known method as described above, step S3 may read the position information depending on the type of browser program. Step S4 displays, on the display screen of the display unit 25, a window (or field) to which the input information such as the comments is to be input.

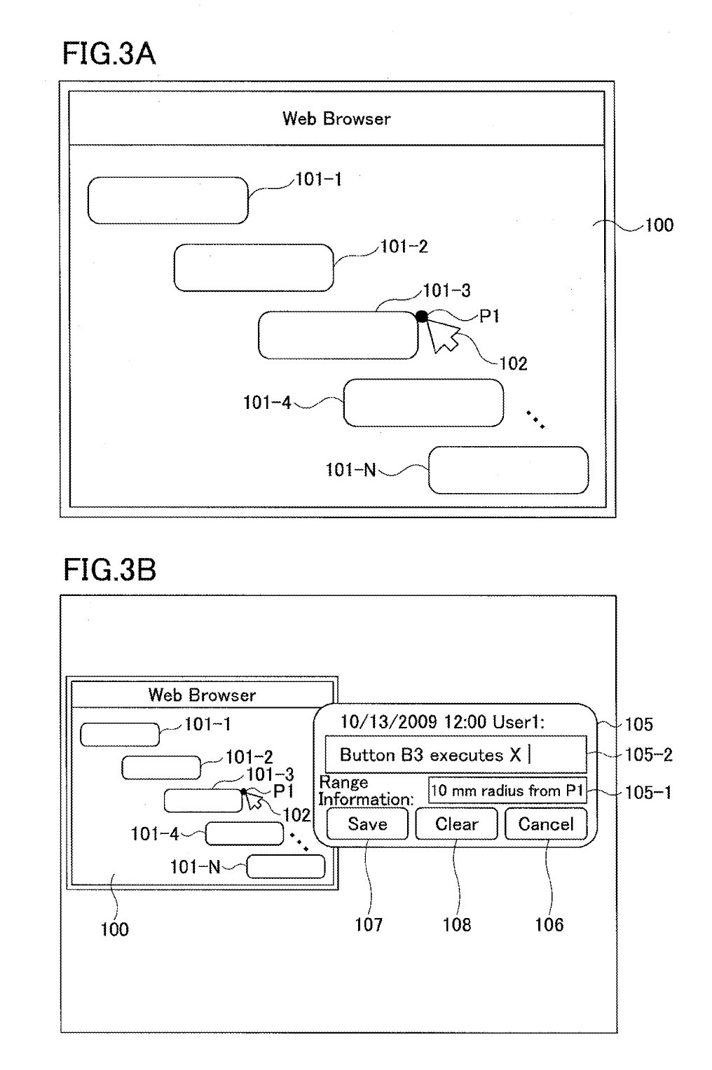

FIGS. 3A and 3B are diagrams for explaining an example of the Web page. FIG. 3A illustrates an example of the Web page displayed on the screen of the display unit 25, and FIG. 3B illustrates an example of a window displayed on the screen. A Web page 100 illustrated in FIG. 3A may include a plurality of regions 101-1 through 101-N, where N is a natural number greater than or equal to 2, and information may be displayed within each of the regions 101-1 through 101-N. The information displayed within each of the regions 101-1 through 101-N may include text written in a language such as English, still image, dynamic image, operation buttons, and the like. The still image and the dynamic image may include graphics, photograph, animation, and the like, which may be in color or be monochromatic. A cursor 102 is movable to a position on the screen by operating the input device 24. In this example, the cursor 102 points a position P1 at a top right end of the region 101-3.

Shapes and layout of the regions 101-1 through 101-N of the Web page 100 may be arbitrary, and are not limited to the shapes and layout illustrated in FIG. 3A. In addition, the shape and layout of the window 105 may be arbitrary, and are not limited to the shapes and layout illustrated in FIG. 3B.

Step S5 decides whether a cancel button 106 displayed in the window 105 illustrated in FIG. 3B is selected by the operation made by the user from the input device 24. The process returns to step S1 when the decision result in step S5 is YES. On the other hand, when the decision result in step S5 is NO, step S6 reads the present time from an internal clock (or timer) of the CPU 21, for example. The read present time may be used as a time when the information adding process with respect to the Web page 100 is executed. Step S7 reads a user name of the CPU 21 from the storage unit 23. Step S8 reads range information that is input to the field 105-1 and input information such as comments input to the field 105-2 in the window 105 by the operation made by the user from the input device 24. As will be described later, the range information may indicate a range from a specified position. In this example, range information “10 mm radius from P1” indicating the range having a radius of 10 mm from the position P1 is input to the field 105-1. In addition, a button B3 is displayed in the region 101-3, and input information “button B3 executes process X”, for example, is input to the field 105-2.

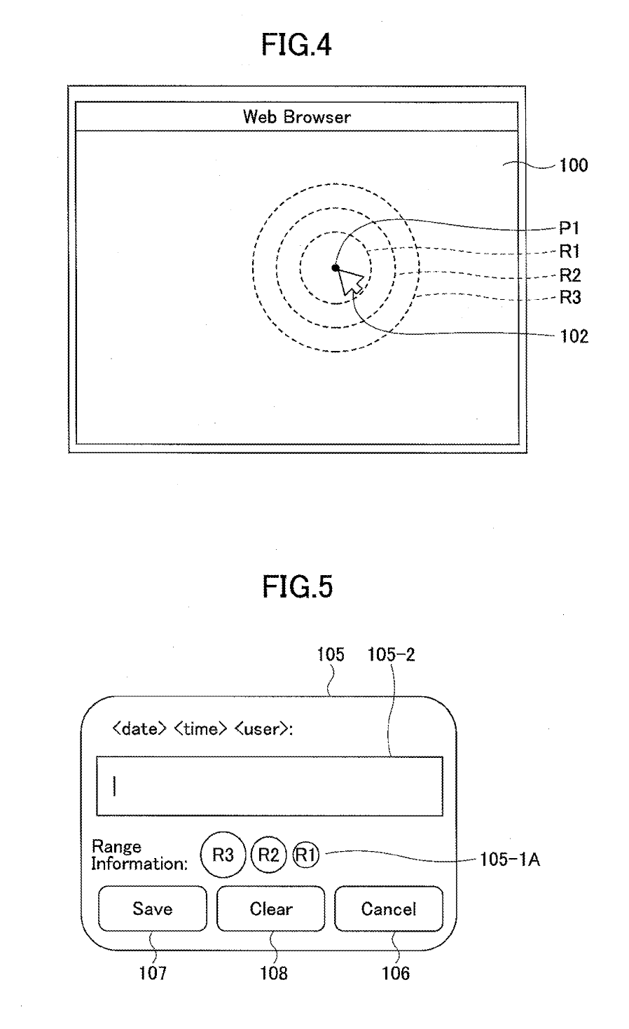

FIG. 4 is a diagram for explaining the range information. FIG. 4 illustrates a case in which ranges having radii of R1, R2, and R3 are set from the specified position P1, where R1<R2<R3. When a plurality of specified positions exist on the Web page 100 and the range information is set to the relatively large radius R, for example, the ranges respectively having the radius R3 from two or more different specified positions may overlap. Accordingly, as the number of specified positions on the Web page 100 becomes larger, the range information may be set smaller.

FIG. 5 is a diagram for explaining a setting of the range information. In FIG. 5, those parts that are the same as those corresponding parts in FIGS. 3A and 3B are designated by the same reference numerals, and a description thereof will be omitted. In the window 105 illustrated in FIG. 5, a range information setting part 105-1A in place of the field 105-1 for directly inputting the range information. The range information setting part 105-1A may urge the user to select the range information from a plurality of range information that are set in advance. In this example, a button R1 to select a small range having the radius R1, a button R2 to select a medium range having the radius R2, and a button R3 to select a large range having the radius R3 is displayed in the range information setting part 105-1A. Because the range information indicated by the selected button may be set, the user may easily set the appropriate range information by visually confirming the size of the range information indicated by the buttons R1, R2, and R3. Of course, the shape and layout of the buttons R1 through R3 may be arbitrary, and are not limited to the shapes and layout illustrated in FIG. 5.

Step S9 decides whether a save button 107 displayed in the window 105 illustrated in FIG. 3B is selected by the operation made by the user from the input device 24. The process returns to step S1 when the decision result in step S9 is NO. On the other hand, when the decision result in step S9 is YES, step S10 stores the URL, the position information of the cursor 102, the present time (that is, the time when the information adding process is executed), the user name, the input information, and the range information that are read into a local file within the storage unit 23, and closes the window 105, and the process ends.

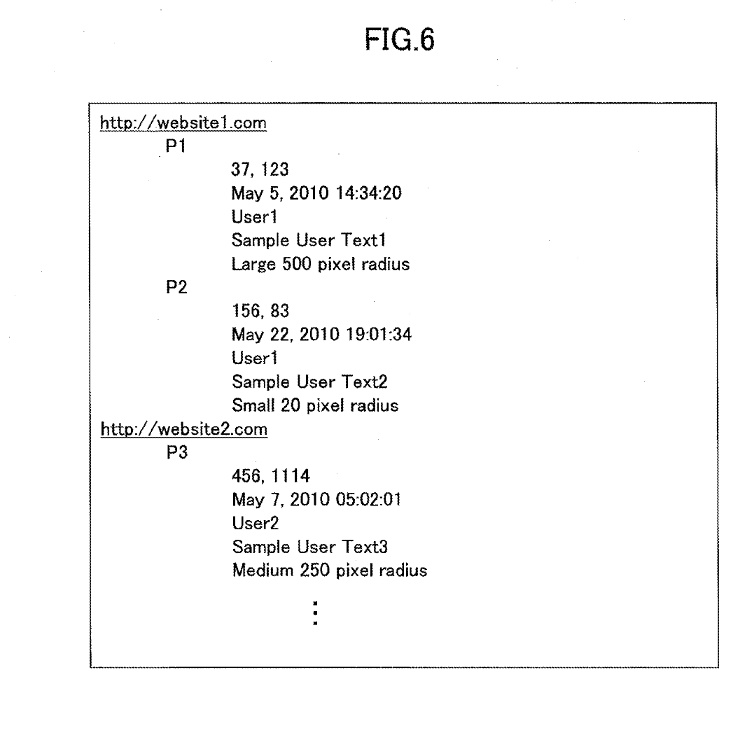

FIG. 6 is a diagram for explaining an example of the information stored in the local file. In the example illustrated in FIG. 6, with respect to the position P1 (or the window 105 to be displayed for the position P1) of the screen of a Web page “http://website1.com”, the local file stores position information “37, 123” indicating the position of the cursor 102 in XY coordinates with reference to an origin of the screen of the Web page, present time “May 5, 2010 14:34:20”, user name “User1”, input information “Sample User Text1”, and range information “large, 500 pixel radius”. In addition, with respect to the position P2 (or the window 105 to be displayed for the position P2) of the screen of a Web page “http://website1.com”, the local file stores position information “156, 83” indicating the position of the cursor 102 in XY coordinates with reference to the origin of the screen of the Web page, present time “May 22, 2010 19:01:34”, user name “User1”, input information “Sample User Text2”, and range information “small, 20 pixel radius”. Further, with respect to the position P3 (or the window 105 to be displayed for the position P3) of the screen of a Web page “http://website2.com”, the local file stores position information “456, 1114” indicating the position of the cursor 102 in XY coordinates with reference to the origin of the screen of the Web page, present time “May 7, 2010 05:02:01”, user name “User2”, input information “Sample User Text3”, and range information “medium, 250 pixel radius”. By storing, in the local file, the position information indicating the position of the cursor 102 in XY coordinates with reference to the origin of the screen of the Web page, it may be unnecessary to perform a coordinate conversion process on the position information depending on the type of browser program, even when the origin (or reference point) of the coordinate system of the display screen differs depending on the type of browser program.

In the example illustrated in FIG. 3B, the present time “10/13/2009” and “12:00” and the user name “User1” are displayed within the window 105, however, the present time and the user name do not need to be displayed within the window 105. In addition, in the example illustrated in FIG. 3B, the sizes of the Web page 100 and the window 105 are respectively reduced and displayed on the screen so that both the Web page 100 and the window 105 are visible approximately in their entirety (that is, so that the Web page 100 and the window 105 do not overlap), in order to enable the user to input the input information to the field 105-2 of the window 105 while monitoring the region 101-3 and the position P1. However, the display format of the window 105 is not limited to the example illustrated in FIG. 3B, as long as the user is able to make the input with respect to the window 105. For example, the window 105 may be displayed to overlap the Web page 100 on the screen, and the Web page 100 or the window 105 may be displayed without reducing the size thereof.

When a clear button 108 displayed in the window 105 illustrated in FIG. 3B is selected by the operation made by the user from the input device 24, at least a part of the range information that is being input to the field 105-1 in the window 105 may be cleared, or at least a part of the input information, such as the comments, that is being input to the field 105-2 in the window 105 may be cleared.

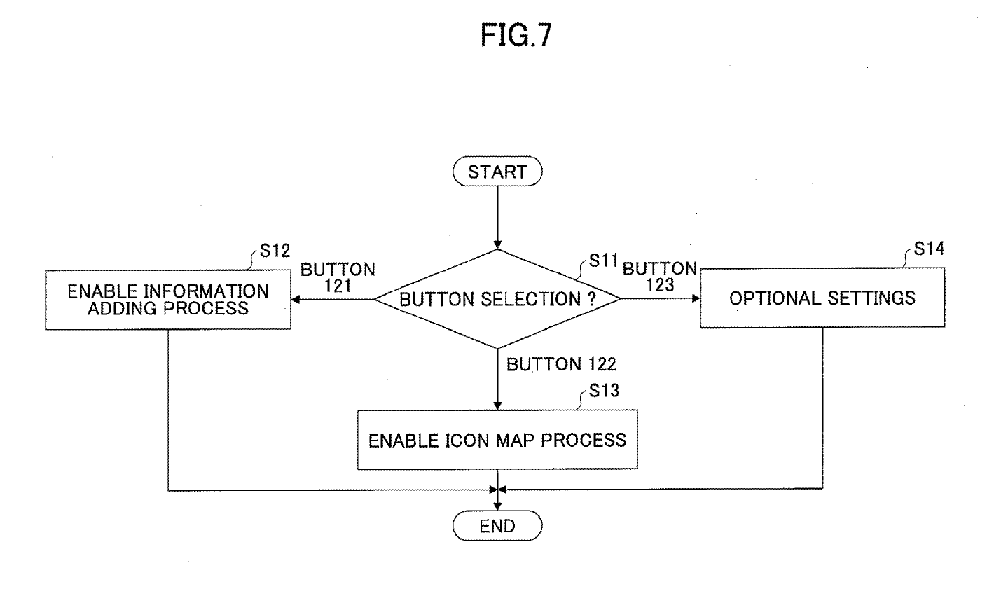

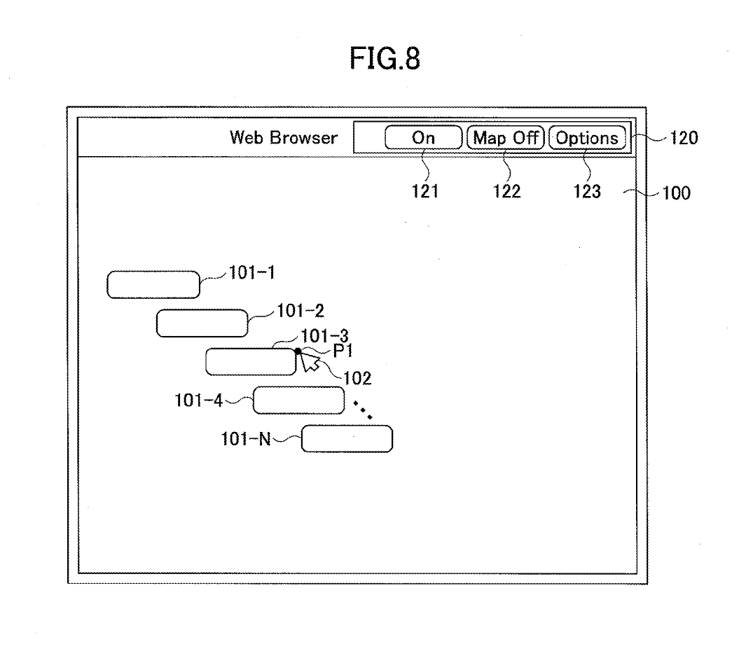

FIG. 7 is a flow chart for explaining an example of procedures of a setting process. In FIG. 7, step S11 decides a button selection state related to the information adding process. Although omitted in FIG. 3A for the sake of convenience, the screen of the display unit 25 may display a toolbox 120 illustrated in FIG. 8, for example, in addition to the Web page 100. FIG. 8 is a diagram illustrating an example of selection buttons for the information adding process. As illustrated in FIG. 8, an On/Off button 121 to turn the information adding process On or Off, a map On/Off button 122 to turn an icon map process On or Off, and an options button 123 to set options may be displayed within the toolbox 120.

When the On/Off button 121 is selected and the information adding process is turned On, step S12 displays “On” on the On/Off button 121 and sets the information adding process illustrated in FIG. 2 to an enabled state, and the process ends. When the On/Off button 121 is not selected, “Off” is displayed on the On/Off button 121 and the information adding process illustrated in FIG. 2 is set to a disabled state.

When the map On/Off button 122 is selected and the icon map process is turned On, step S13 displays “Map On” on the map On/Off button 122 and sets the icon map process to an enabled state when the information adding process is in the enabled state, and the process ends. When the map On/Off button 122 is not selected, “Map Off” is displayed on the map On/Off button 122, and the icon map process is set to a disabled state even when the information adding process is in the enabled state.

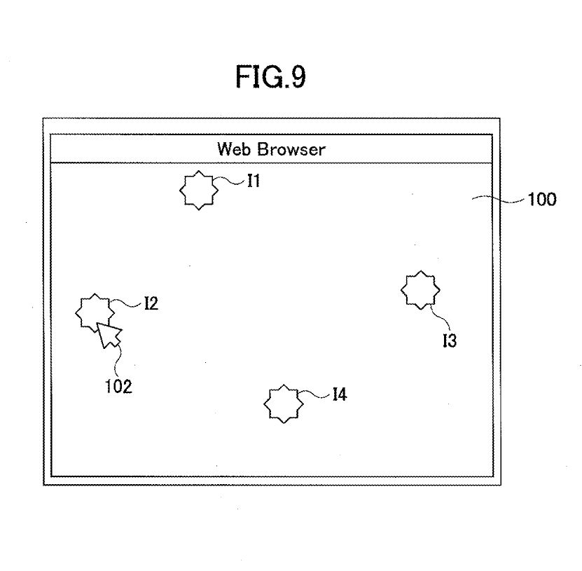

FIG. 9 is a diagram for explaining the icon map process. In FIG. 9, those parts that are the same as those corresponding parts in FIG. 3A are designated by the same reference numerals, and a description thereof will be omitted. The icon map process may register icons I1 through I4 at specified positions on the screen of the Web page 100 illustrated in FIG. 9. When the map On/Off button 122 illustrated in FIG. 8 is selected and the icon map process is turned On, the icon map process is set to the enabled state when the information adding process is in the enabled state. In the enabled state of the icon map process, the registered icons I1 through I4 are displayed at positions specified at the time when the icons I1 through I4 are registered, and an icon may also be registered at a newly specified position. Hence, it may be possible to notify the user of the position where the input information, such as the comments, is added. In addition, when the mouse is clicked in a state in which the cursor 102 overlaps the icon I2, for example, and the position of the cursor 102 is specified by the user from the input device 24, this specifying of the cursor position may be used as a trigger (that is, generate a trigger) to display corresponding input information stored in the local file on the screen as will be described later. In this case, when the user wishes to refer to the input information added with respect to the specified region of the Web page 100, the user may select the corresponding icon by operating the input device 24 in order to display the input information.

The icons I1 through I4 may have the same shape, size, and color, or may have mutually different shapes, sizes, and colors. In addition, the size of the icons I1 through I4 may be adjusted in order to adjust an overlapping range with the cursor 102. Size information of the icons I1 through I4 may be stored in an icon map file within the storage unit 23, for example, for each Web page, together with the position information indicating the registered positions of the icons I1 through I4.

When the options button 123 is selected, step S14 in FIG. 7 may display a screen (not illustrated) for making various optional settings, in order to enable optional settings. The optional setting may specify a storage location of the local file, specify a selection recognition time that determines a number of seconds the cursor 102 is to remain at the same position or within the same range in order to determine that recorded input information, such as the comments, is to be displayed as will be described later, specify a correction or modification of the information adding program, and specify existence of help information, for example.

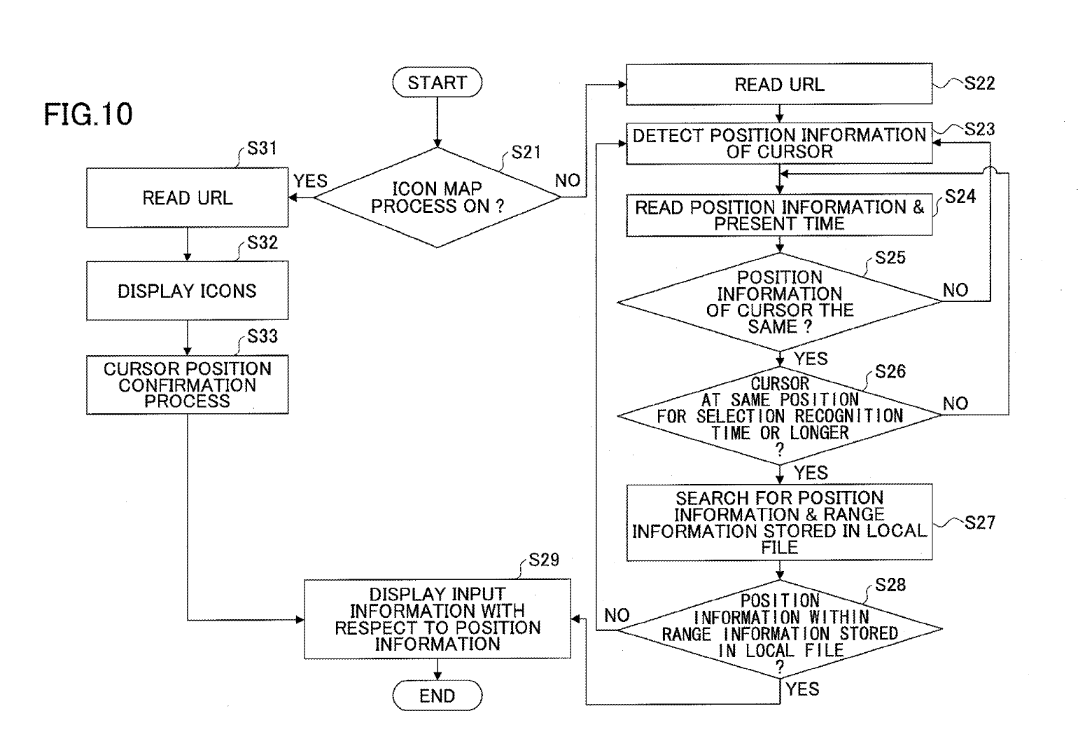

FIG. 10 is a flow chart for explaining an input information display process. The process illustrated in FIG. 10 may be executed by the CPU 21. It is assumed for the sake of convenience that the display process illustrated in FIG. 10 is started when the Web page 100 is already displayed on the screen of the display unit 25 by the operation described above, and the On/Off button 121 is selected on the screen illustrated in FIG. 8 and the information adding process is in the enabled state. In addition, it is also assumed for the sake of convenience that the selection recognition time that determines the number of seconds the cursor 102 is to remain at the same position or within the same range in order to determine that recorded input information, such as the comments, is to be displayed is set in advance by a default setting or by the optional setting described above.

In FIG. 10, step S21 decides whether the mp On/Off button 122 is selected on the screen illustrated in FIG. 8 and the icon map process is turned On. When the decision result in step S21 is NO, step S22 reads the URL of the displayed Web page 100. Step S23 detects the position information of the cursor 102 for every predetermined time, for example, while the cursor 102 moves on the screen of the Web page 100 in response to the operation made by the user from the input device 24, such as the operation of the mouse. Step S24 reads the position information of the present position of the cursor 102, and reads the present time from the internal clock (or timer) of the CPU 21, for example. Step S25 reads the position information of the cursor 102 after the predetermined time and the present time, and decides whether the position information of the cursor 102 is the same (or unchanged). When the decision result in step S25 is NO, the process returns to step S23. On the other hand, when the decision result in step S25 is YES, step S26 decides whether the time for which the cursor 102 is located at the same position is the selection recognition time or longer, based on a difference between the present time that is currently read and the time when the same position information is first read. When the decision result in step S26 is NO, the process returns to step S24.

When the decision result in step S25 is YES, step S27 searches for the position information and the range information of the cursor 102 stored with respect to the Web page 100 that is being browsed, in the local file within the storage unit 23. Step S28 decides whether, as a result of the search, the position information within the range information from the position information indicating the present position of the cursor 102 is stored in the local file with respect to the Web page 100 that is being browsed. When the decision result in step S28 is NO, the process returns to step S23. On the other hand, when the decision result in step S28 is YES, step S29 reads the input information stored in the local file with respect to the position information that is found by the search, because the position information within the range information from the position information indicating the present position of the cursor 102 is stored in the local file with respect to the Web page 100 that is being browsed, and displays the read input information on the screen of the Web page 100 that is being browsed.

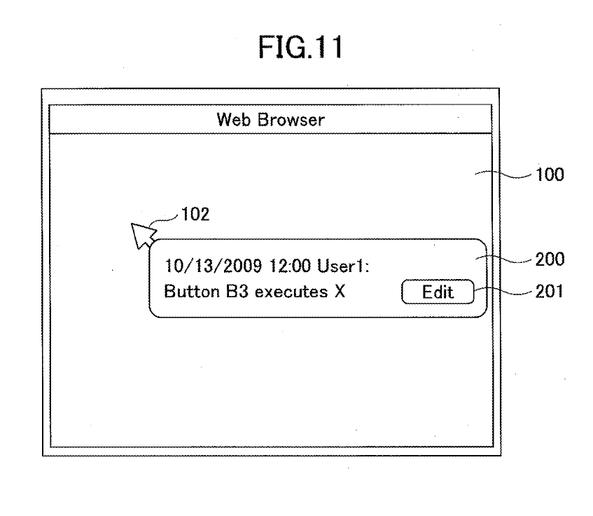

When the input information described with reference to FIG. 3B is stored in the local file with respect to the position P1, a popup display 200 illustrated in FIG. 11 may be made to automatically display the input information “button B3 executes process X”, for example. FIG. 11 is a diagram for explaining an example of the popup display, and illustration of the regions 101-1 through 101-N and the like will be omitted. The input information may be edited by selecting an edit button 201 within the popup display 200 and editing the input information by making an addition, deletion, and the like with respect to the input information. In this case, when the edit button 201 is selected, buttons similar to the buttons 106 through 108 illustrated in FIG. 3B are displayed within the popup display 200, in order to enable editing of the input information in a manner similar to the time when the input information is input. The editing of the input information may be reflected to the input information stored in the local file. The shape and position of the popup display 200 displayed on the screen of the Web page 100 that is being browsed may be arbitrary, and are not limited to the shape and position illustrated in FIG. 11.

On the other hand, when the decision result in step S21 is YES, step S31 reads the URL of the Web page 100 that is being displayed. In this example, step S32 displays the icons I1 through I4 with icon sizes corresponding to the positions specified at the time when the icons I1 through I4 are registered, on the Web page 100 that is being browsed as illustrated in FIG. 9, based on the position information and the size information of the icons I1 through I4 stored in the icon map file with respect to this Web page 100. Step S33 performs a first cursor position confirmation process or a second cursor position confirmation process. The first cursor position confirmation process may use the overlap of the cursor 102 and the icon as a trigger for the display of the input information by the popup display 200 and the like. On the other hand, when the position of the cursor 102 determined (or the display of the input information is instructed) from the input device 24 by a click operation of the mouse and the like in a state in which the cursor 102 and the icon overlap, the second cursor position confirmation process may use this determination of the position of the cursor 102 as a trigger for the display of the input information by the popup display 200 and the like.

The first cursor position confirmation process may decide, based on the position information and the size information of the icons I1 through I4 stored in the icon map file, whether the present position indicated by the position information of the cursor 102 overlaps one of the icons I1 through I4 stored in the icon map file, and advance the process to step S29 using the detection of the overlap as the trigger. On the other hand, the second cursor position confirmation process may detect the overlap between the cursor 102 and the icons I1 through I4 stored in the icon map file, in a manner similar to the first cursor position confirmation process, and when the overlap is detected and the position of the cursor 102 is determined in the overlapped state, advance the process to step S29 using the detection of the overlap and the determination of the cursor position in the overlapped state as the trigger.

Because the position information within the range information from the position information indicating the present position of the cursor 102 overlapping the icon is stored in the local file with respect to the Web page 100 that is being browsed, step S29 reads the input information that is stored in the local file with respect to the position information within the range information from the position information indicating the present position of the cursor 102 overlapping the icon, and displays the read input information on the screen of the Web page 100 that is being browsed.

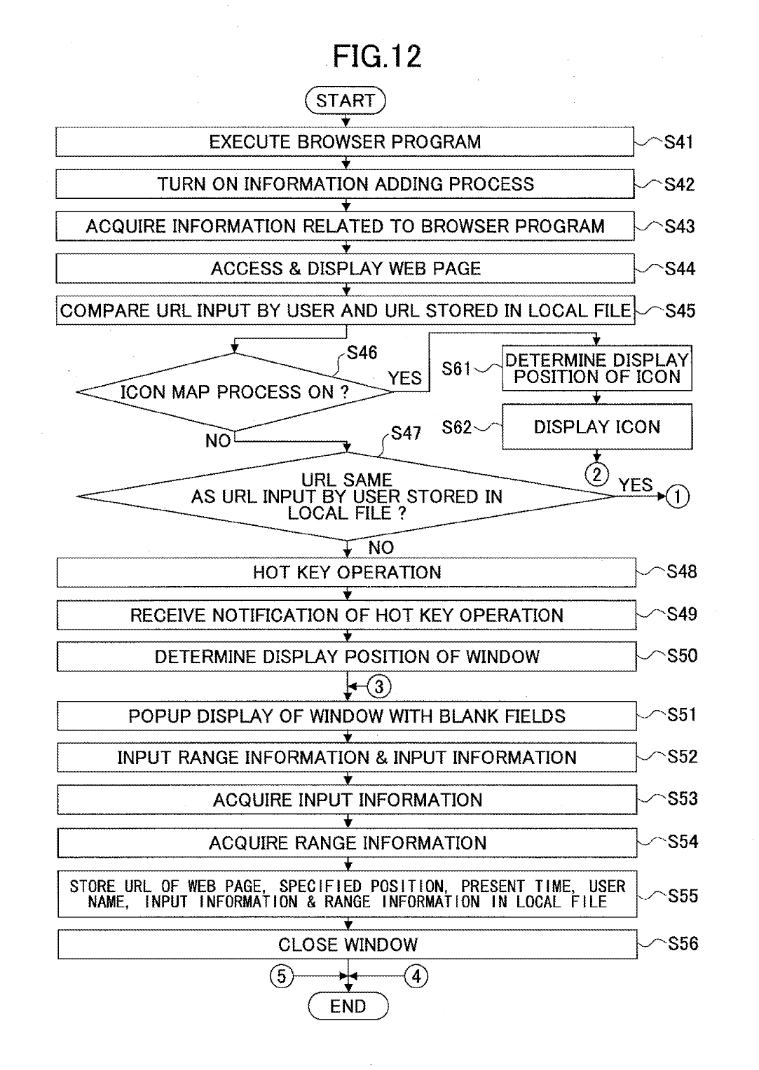

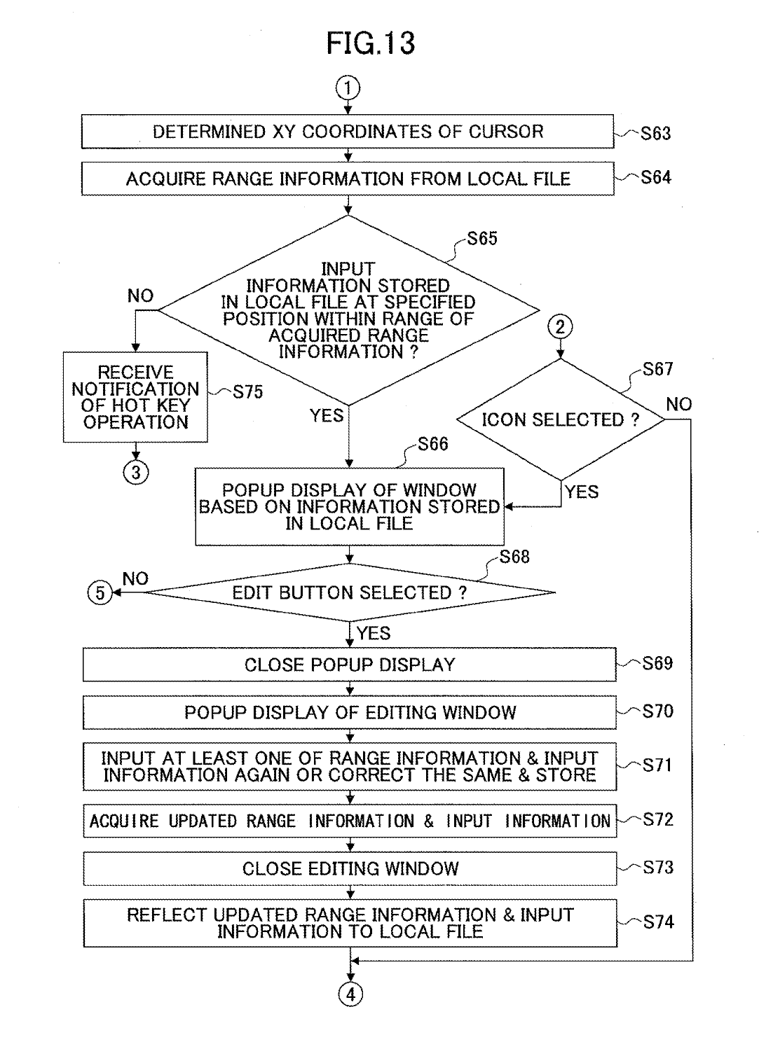

Next, a description will be given of an example of a series of processes performed by the computer system 2, by referring to FIGS. 12 and 13. FIGS. 12 and 13 are flow charts illustrating an example of the information adding process including user operations.

In step S41 illustrated in FIG. 12, the user operates the input device 24 in order to instruct the CPU 21 to execute the browser program. In step S42, the user selects the On/Off button 121 illustrated in FIG. 8 in order to turn On the information adding process. In step S43, the CPU 21 acquires information related to the browser program, including the type of browser program. In step S44, the user operates the input device 24 to input the URL and make access to the Web page to be browsed, in order to display the Web page 100 illustrated in FIG. 3A on the screen of the display unit 25. In step S45, the CPU 21 executes the information adding program, and the information adding program compares the URL input by the user and the URL stored in the local file within the storage unit 23. In step S46, the CPU 21 decides whether the user selected the map On/Off button 122 illustrated in FIG. 8 by operating the input device 25 in order to turn On the icon map process. The process advances to step S61 to be described later when the decision result in step S46 is YES.

On the other hand, the process advances to step S47 when the decision result in step S46 is NO. In step S47, the CPU 21 decides whether the local file stores the URL that is the same as the URL input by the user in step S45. The process advances to step S63 to be described later when the decision result in step S47 is YES. Steps S48 through S56 are performed when the decision result in step S47 is NO.

In step S48, the user performs a hot key operation by operating the input device 24 and moving the cursor 102 to an arbitrary position. In step S49, the information adding program is notified of the hot key operation. In step S50, the information adding program determines the XY coordinates of the display position of the window 105 illustrated in FIG. 3B to be displayed on the screen of the Web page 100 that is being browsed, based on the position of the cursor 102 with reference to the origin. In step S51, the information adding program makes a popup display of the window 105 at the determined position on the screen, in a state in which the fields 05-1 and 105-2 are blank. In step S52, the user operates the input device 24 in order to input the range information and the input information to the fields 105-1 and 105-2, respectively, and to select the save button 107. In step S53, the information adding program acquires the input information input to the field 105-2. In step S54, the information adding program acquires the range information input to the field 105-1. In step S55, the information adding program stores the URL of the Web page 100 that is being browsed, the specified position (that is, the position of the cursor 102) on the screen of the Web page 100, the present time acquired from the internal clock of the CPU 21, for example, the user name acquired from the storage unit 23, for example, the acquired input information, and the acquired range information into the local file within the storage unit 23. In step S56, the information adding program closes the window 105 displayed on the screen of the Web page 100, and the process ends.

Next, a description will be given of a process that is performed when the decision result in step S46 is YES. In step S61, the information adding program determines the display positions of the icons I1 through I4 illustrated in FIG. 9 to be displayed on the screen of the Web page 100 that is being browsed, based on the XY coordinates of each of the windows 105 stored in the local file within the storage unit 23 with reference to the origin. In step S62, the information adding program displays, on the screen of the Web page 100, the icons I1 through I4 indicating that the input information is stored, based on the icon map file. In step S67 illustrated in FIG. 13, the CPU 21 decides whether one of the icons I1 through I4 is selected by the user. The process ends when the decision result in step S67 is NO. The process advances to step S66 to be described later when the decision result in step S67 is YES.

Next, a description will be given of a process that is performed when the decision result in step S47 is YES. In step S63 illustrated in FIG. 13, the information adding program determines the XY coordinates of the cursor 102 on the screen of the Web page 100 with reference to the origin. In step S64, the information adding program acquires the range information stored with respect to the Web page 100 in the local file within the storage unit 23. In step S65, the information adding program decides whether the local file stores the input information at the specified position within the range indicated by the acquired range information from the position of the cursor 102 on the screen of the Web page 100. When the decision result in step S65 is NO, in step S75, the information adding program is notified of the hot key operation, and the process advances to step S51 illustrated in FIG. 12.

On the other hand, the process advances to step S66 when the decision result in step S65 or step S67 is YES. In step S66, the information adding program makes a popup display of the window 105 on the screen of the Web page 100 based on the information stored in the local file. In step S68, the CPU 21 decides whether the edit button 201 within the popup display 200 illustrated in FIG. 11 is selected by the user, and the process ends when the decision result in step S68 is NO.

The process advances to step S69 when the decision result in step S68 is YES. In step S69, the information adding program closes the popup display 200 that is being displayed. In step S70, the information adding program makes a popup display of an editing window, such as the window 105 illustrated in FIG. 3B, for example, on the screen of the Web page 100. In step S71, the user inputs at least one of the range information and the input information again to the fields 105-1 and 105-2 of the window 105, or corrects at least one of the range information and the input information, before selecting the save button 107. In step S72, the information adding program acquires the range information and the input information that are updated by the user in step S71. In step S73, the information adding program closes the editing window, that is, the window 105 in this example. In step S74, the information adding program reflects the acquired, updated range information and input information to the local file, and the process ends.

Accordingly, the input information, such as the comments, input by the user with respect to an arbitrary portion of the Web page, may be stored in the local file. For this reason, by making the local file inaccessible from the outside, security of the information stored in the local file may be secured.

The user may simply specify a position in the arbitrary portion of the Web page, and input the input information, such as the comments, within the window that is automatically displayed on the screen of the Web page. Hence, the input information may be stored in the local file and added with respect to the Web page, without requiring the use to be aware of the correspondence between the input information and the Web page. Consequently, it may be unnecessary for the user to create, by himself, a file for storing the input information, or to perform a troublesome operation of relating the input information to the Web page. In addition, the user may input the input information in an arbitrary description language that does not depend on the description language of the Web page. For this reason, the user need not have knowledge of the HTML codes, for example, unlike the third conventional method described above. Furthermore, the Web page itself need not be modified when adding the input information with respect to the Web page.

The input information stored in the local file may be displayed automatically when the cursor moves to a vicinity of a corresponding position on the screen of the Web page that is being browsed, displayed based on the instruction from the user. In the case of the automatic display of the input information, the input information that is added (or stored) with respect to a portion of the Web page may be displayed without requiring the user to be aware of the correspondence between the input information and the Web page. For this reason, the input information may be displayed to suit the user's preference or taste.

Accordingly, it may be possible add input information, such as comments, with respect to a portion of the Web page by a relatively simple operation, in a description language that does not depend on the description language of the Web page, when browsing the Web page. In addition, the input information added to the Web page may be displayed when browsing the Web page, without requiring the user to be aware of the correspondence between the input information and the Web page, or based on the instruction from the user. Furthermore, the input information may be written in an arbitrary language, such as English, that does not depend on the language, such as Japanese, with which the Web page is written.

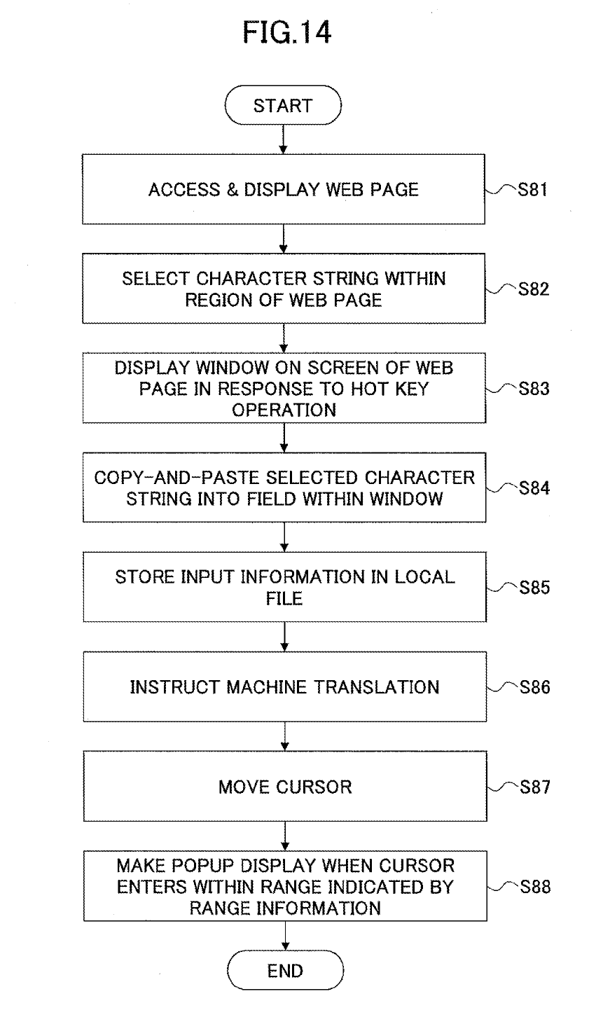

Next, a description will be given of an example of a translation of the input information into an arbitrary language, by referring to FIGS. 14 through 17. FIG. 14 is a flow chart for explaining an example of an input information adding process including translation. In the input information adding process illustrated in FIG. 14, the procedures to store the input information and the like in the local file while browsing the Web page, the procedures to make the popup display of the input information and the like stored in the local file when browsing the Web page, and the like may be similar to those described above in conjunction with FIGS. 2, 7, 10, 12, and 13, and thus, detailed description and illustration thereof will be omitted.

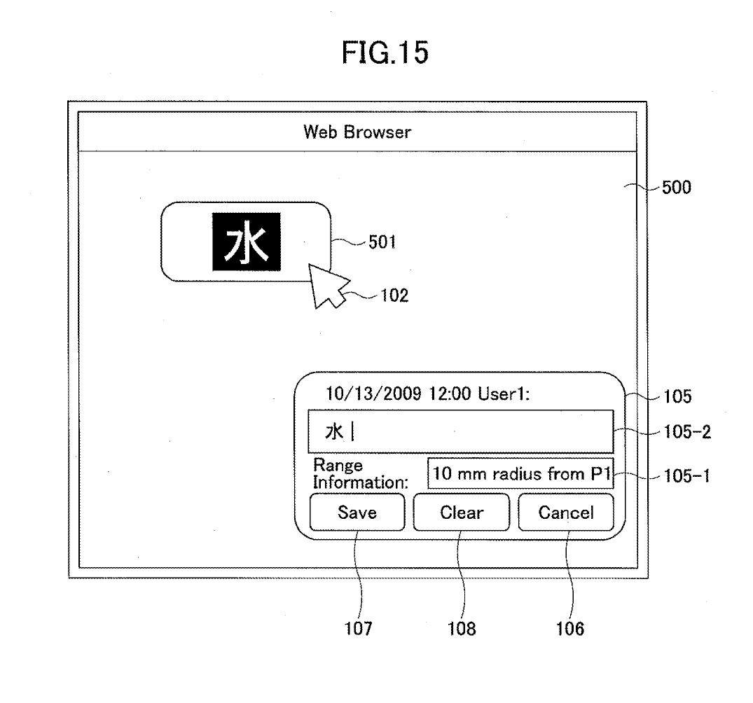

In step S81 illustrated in FIG. 14, the user operates the input device 24 in order to make access to a Web page 500 in Japanese illustrated in FIG. 15, for example, and display the Web page 500 on the screen of the display unit 25. FIG. 15 is a diagram illustrating an example of the Web page, and those parts that are the same as those corresponding parts in FIG. 3B are designated by the same reference numerals, and a description thereof will be omitted. In step S82, the user operates the input device 24 and selects a character string within a region 501 of the Web page 500, for example. It is assumed for the sake of convenience that the character string is made up of one or more characters, including numerals and symbols, and forms one or more words. In step S83, the input information adding program displays the window 105 on the screen of the Web page 500 in response to the hot key operation made by the user from the input device 24, for example. In step S84, the user operates the input device 24 in order to perform a copy-and-paste process in which the character string selected in step S82 is copied into the field 105-2 within the window 105. In this example, a character string “ [symbol] ” in Japanese, which is a Japanese Kanji character for “water”, is input to the field 105-2 by the copy-and-paste process.

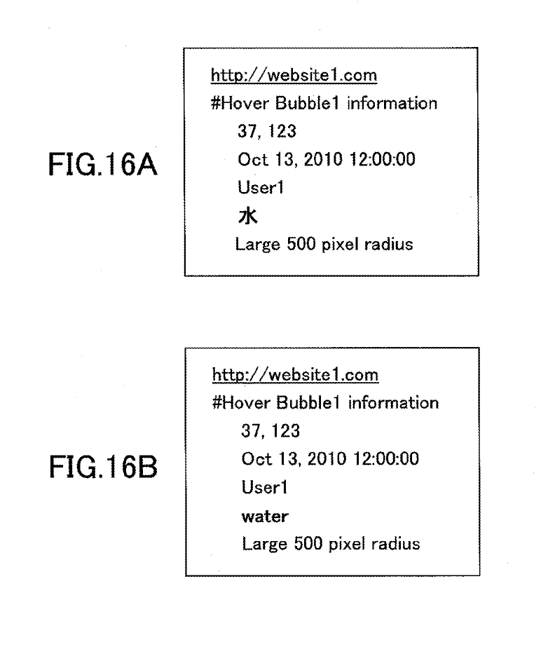

In step S85, the input information adding program stores the information input to the window 105 with respect to the Web page 500, in the local file illustrated in FIG. 16A within the storage unit 23. FIGS. 16A and 16B are diagrams for explaining an example of the information stored in the local file. In step S86, the user operates the input device 24 and instructs a machine translation of the input information into another, arbitrarily selectable language. In this example, it is assumed for the sake of convenience that the machine translation into English is selected, and a known Japanese-English dictionary used for the machine translation is prestored within the storage unit 23. Hence, the local file illustrated in FIG. 16A may be converted into a local file illustrated in FIG. 16B in which the input information “ [symbol] ” in Japanese is translated into the input information “water” in English by the machine translation.

The dictionary (or tool) used for the machine translation may be provided outside the computer system 2, and may be accessible via the network 3, for example. The CPU 21 may include a known translator to execute the machine translation using the dictionary (or tool). In addition, although the machine translation is executed in response to the user's instruction in step S86, an automatic translation mode may be selectable. When the automatic translation mode is selected, the input information stored in the local file may be translated into a predetermined language automatically.

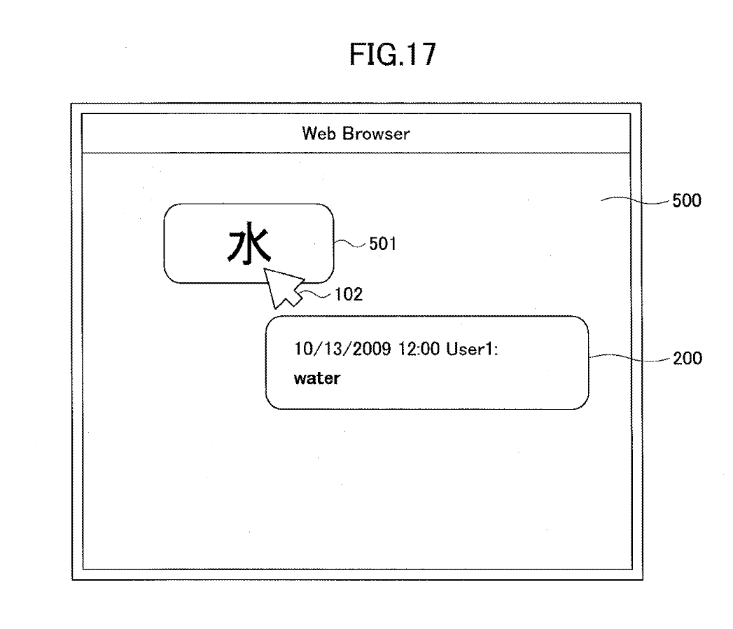

After the input information is stored in the local file and subjected to the machine translation, the user operates the input device 24 in step S87 in order to move the cursor 102 on the screen of the Web page 500. In step S88, when the cursor 102 enters the range indicated by the range information from the specified position of the region 501, the input information adding program makes a popup display 200 illustrated in FIG. 17 on the screen of the Web page 500. FIG. 17 is a diagram for explaining an example of the popup display. The machine-translated input information “water” is displayed within the popup display 200. as illustrated in FIG. 17.

Both the local file before the conversion (that is, before the machine translation) illustrated in FIG. 16A and the local file after the conversion (that is, after the machine translation) illustrated in FIG. 16B may be stored in the storage unit 23, in order to enable the user to operate the input device 24 and select the information within the local file to be displayed in the popup display 200.

In addition, the input information is not limited to the character string copied from the Web page 500, and may be a character string that is input by the user by operating the input device 24.

By providing the machine translation function to translate the input information, the information of the Web page may be utilized more easily and effectively. In addition, the input information added and stored with respect to the Web page may be displayed in a desired language.

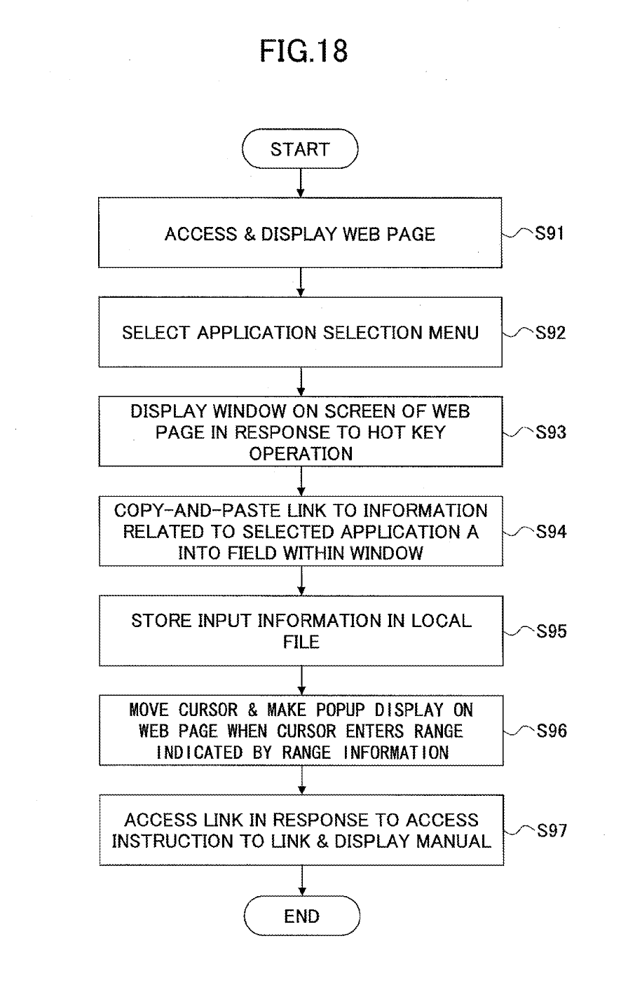

Next, a description will be given of an example in which a link is included in the input information, by referring to FIGS. 18 through 21. FIG. 18 is a flow chart for explaining an example of the input information adding process including links. In the input information adding process illustrated in FIG. 18, the procedures to store the input information and the like in the local file while browsing the Web page, the procedures to make the popup display of the input information and the like stored in the local file when browsing the Web page, and the like may be similar to those described above in conjunction with FIGS. 2, 7, 10, 12, and 13, and thus, detailed description and illustration thereof will be omitted.

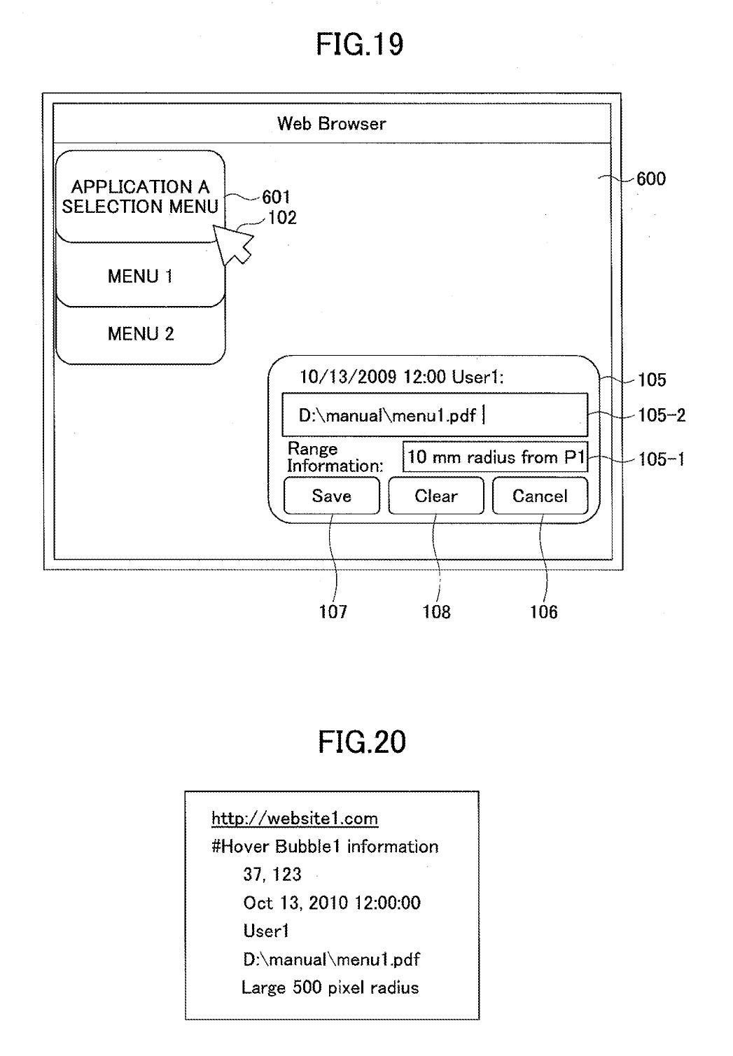

In step S91 illustrated in FIG. 18, the user operates the input device 24 in order to make access to a Web page 600 illustrated in FIG. 19, for example, and display the Web page 600 on the screen of the display unit 25. FIG. 19 is a diagram illustrating an example of the Web page, and those parts that are the same as those corresponding parts in FIG. 3B are designated by the same reference numerals, and a description thereof will be omitted. In step S92, the user operates the input device 24 and selects a region 601 of an application A selection menu of the Web page 600, for example. The application A selection menu may include links to information related to an application (or application program or application software) A. The information related to the application A may include an operation manual describing operation methods and the like of the application A, reference materials, and the like. In step S93, the input information adding program displays the window 105 on the screen of the Web page 600 in response to the hot key operation made by the user from the input device 24, for example. In step S94, the user operates the input device 24 in order to perform a copy-and-paste process in which the link selected in step S92 is copied into the field 105-2 within the window 105. In this example, the link “D:/manual/menu1.pdf” to the operation manual is input to the field 105-2 by the copy-and-paste process.

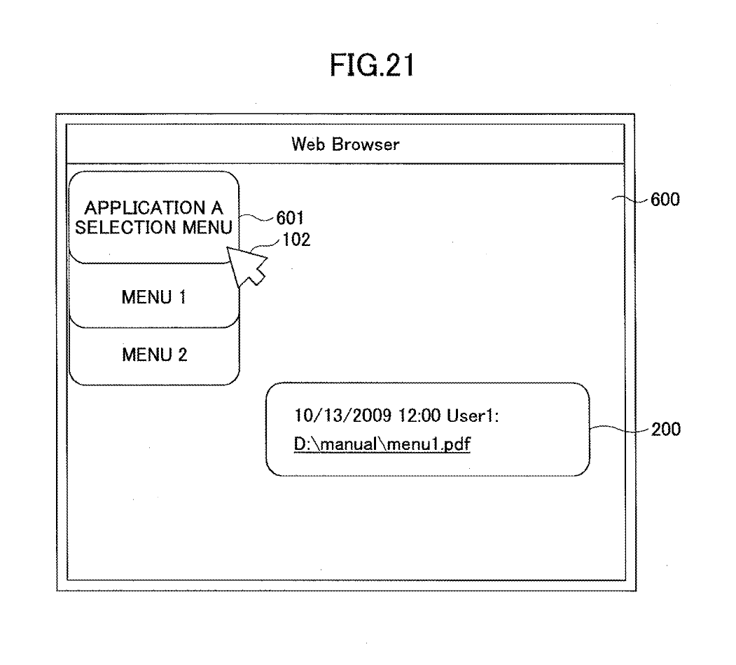

In step S95, the input information adding program stores the information input to the window 105 with respect to the Web page 600 in a local file illustrated in FIG. 20 within the storage unit 23. FIG. 20 is a diagram for explaining an example of the information stored in the local file. After the input information is stored in the local file, the user, in step S96, operates the input device 24 in order to move the cursor 102 on the screen of the Web page 600, and to display a popup display 200 illustrated in FIG. 21 on the screen of the Web page 600 when the cursor 102 enters the range indicated by the range information from the specified position of the region 601. FIG. 21 is a diagram for explaining an example of the popup display. The input information “D:/manual/menu1.pdf” indicating the link to the operation manual of the application A of the Web page 600 is displayed in the popup display 200, as illustrated in FIG. 21. When the user operates the input device 24 in order to select the input information “D:/manual/menu1.pdf” displayed in the popup display 200 in order to instruct an access to the link, in step S97, the input information adding program makes an access to the link “D:/manual/menu1.pdf” via the browser program in response to the instruction to access this link, and displays the operation manual at the link on the screen of the display unit 25.

The link that is input as the input information may be a remote link outside the computer system 2, or a local link inside the computer system 2, such as within the storage unit 23. In addition, although step S97 makes access to the link in response to the user's instruction, an automatic access mode to the link may be selectable. When the automatic access mode is selected, the access to the remote or local link may be made automatically.

The input information is not limited to the link copied from the Web page 600, and may be a link that is input by the user by operating the input device 24.

By providing the function of specifying the link as the input information, the information of the Web page may be utilized more easily and effectively. In addition, it may be possible to display information related to the Web page, such as the operation manual, the reference materials, and the like.

In each of the examples described above, the security may be secured by making the local file within the storage unit 23 inaccessible from the outside. However, in an operation mode in which sharing of the local file is permitted, such as a Web site testing and the like, the local file within the storage unit 23 may be made accessible from the outside.

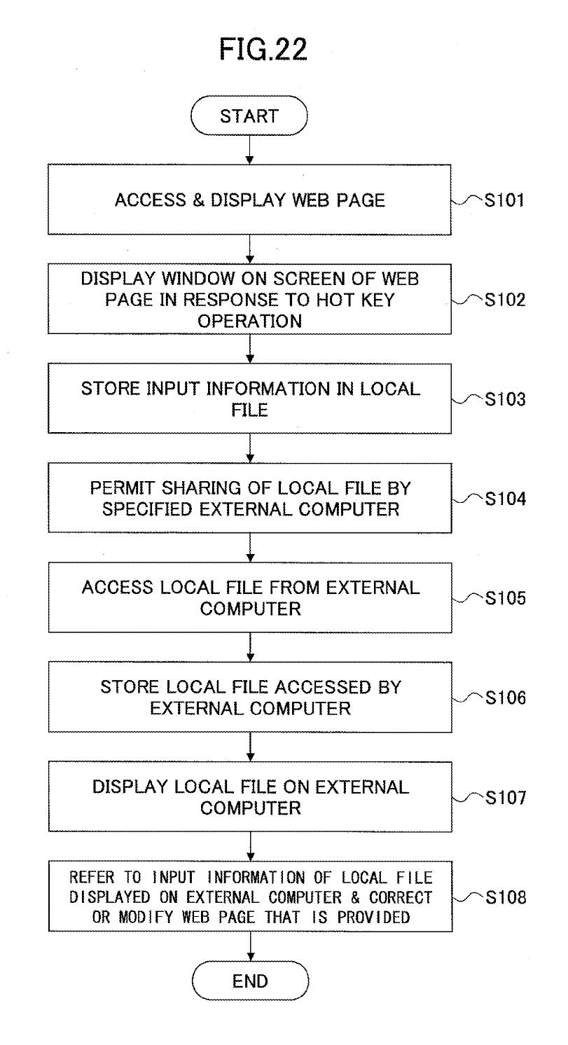

Next, a description will be given of an example in which the sharing of the local file is permitted, by referring to FIGS. 22 through 24. FIG. 22 is a flow chart for explaining the example of the input information adding process that permits sharing of the local file. In the input information adding process illustrated in FIG. 22, the procedures to store the input information and the like in the local file while browsing the Web page, the procedures to make the popup display of the input information and the like stored in the local file when browsing the Web page, and the like may be similar to those described above in conjunction with FIGS. 2, 7, 10, 12, and 13, and thus, detailed description and illustration thereof will be omitted.

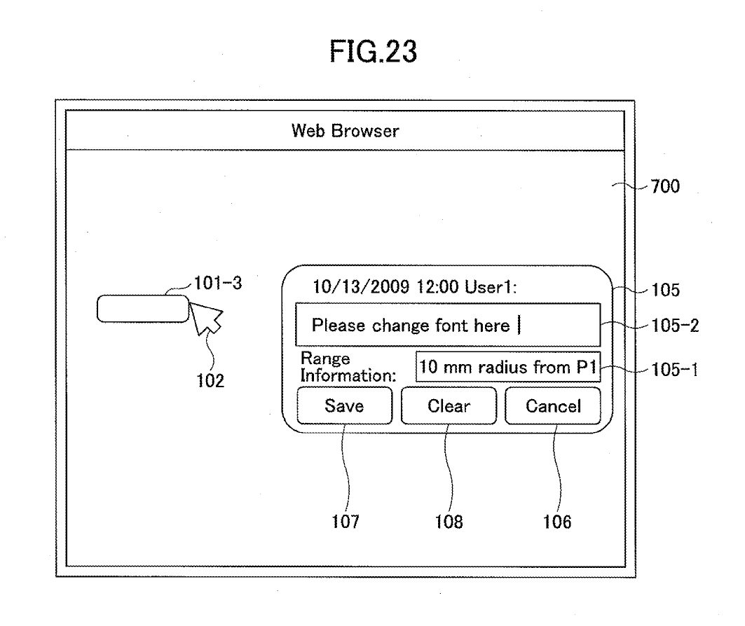

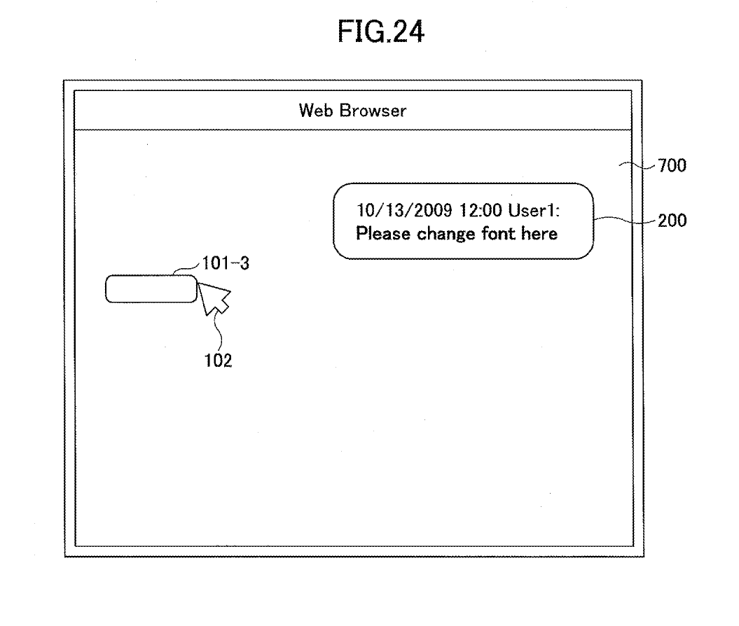

In step S101 illustrated in FIG. 22, the user operates the input device 24 in order to make access to a Web page 700 illustrated in FIG. 23, for example, and display the Web page 700 on the screen of the display unit 25. FIG. 23 is a diagram illustrating an example of the Web page, and those parts that are the same as those corresponding parts in FIG. 3B are designated by the same reference numerals, and a description thereof will be omitted. In step S102, the input information adding program displays the window 105 on the screen of the Web page 700 illustrated in FIG. 24 in response to the hot key operation made by the user from the input device 24, for example. FIG. 24 is a diagram for explaining an example of the window display. In step S103, the input information adding program stores the information input to the window 105 with respect to the Web page 700 in a local file within the storage unit 23. In this example, input information “Please change font here” is input to the field 105-2 of the window 105, in order to indicate that the font is difficult to read. In step S104, the user operates the input device 24 and permits sharing of the local file to one or more external computer systems (not illustrated) that are specified by the user. Hence, the input information within the local file may be accessible from each external computer system that is specified by the user. The external computer system that is permitted to make access to the local file may be specified in advance by a default setting and the like, for example.

In this example, it is a precondition that the Web site testing is to be performed. For this reason, the external computer system permitted to make access to the local file may be a Web site computer that provides the Web site including the Web page 700, or a computer of a manager who performs a process such as development, management, testing, and the like of the Web site.

After the external computer system that is permitted to make access to the local file is specified, in step S105, the manager operates an input device of the external computer in order to make access, via the network 3, to the local file within the storage unit 23 of the computer system 2 with which the external computer is permitted to share the local file. In step S106, the manager operates the input device of the external computer in order to store the local file to which the access is made into a storage unit of the external computer. In step S107, a program of the external computer displays at least the input information within the local file, in response to the operation made by the manager from the input device of the external computer. The display of at least the input information within the local file made by the program of the external computer may include a window similar to the window 105 illustrated in FIG. 24, for example, or only the input information may be displayed by a popup display, for example. In step S108, the manager refers to the input information of the displayed local file, that is, feedback information of the user with respect to the Web page 700, and make corrections or modifications to the Web page 700 that is provided.

By permitting sharing of the local file depending on the operation mode of the computer system, the input information with respect to the Web page may be shared and effectively utilized.

Following steps S104A through S107A may be performed in place of steps S104 through S107. In this case, in step S104A, the user operates the input device 24 in order to permit sharing of the local file by one or more external computer systems, and automatically sends this local file to the one or more external computer systems via the network 3. The local file may be sent to the one or more external computers by electronic mail and the like, for example. In step S105A, the manager operates the input device of the external computer, and stores the local file sent from the computer system 2 into the storage unit of the external computer. In step S106A, the manager operates the input device of the external computer, and reads the local file from the storage unit of the external computer. In step S107A, the program of the external computer displays the read local file, in response to the operation made by the manager from the input device of the external computer.

In this case, the local file that may be shared with one or more external computers may be sent to the one or more external computers, without requiring the user of the computer system 2 to be aware of the sending of the sharable local file, and without requiring the manager of the external computer to be aware of the receiving of the sharable local file from the computer system 2.

Therefore, according to the described embodiments and examples, it may be possible add input information, such as comments, with respect to a portion of the Web page by a relatively simple operation, in a description language that does not depend on the description language of the Web page, when browsing the Web page.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium having stored therein a program for causing a computer to perform a process comprising:
storing, into a file of a storage unit, position information indicating a position on a Web page that is being displayed on a screen of a display unit and specified from an input device, and input information to be added with respect to the position and input from the input device, with respect to the Web page; and
displaying the input information stored in the file on the screen in a vicinity of the position when a cursor on the screen of the display unit displaying the Web page enters a predetermined range from the position indicated by the position information.

2. The non-transitory computer-readable storage medium as claimed in claim 1, wherein the displaying makes a popup display in which the input information is displayed, in the vicinity of the position on the screen of the display unit displaying the Web page, in response to a trigger that is generated when the cursor enters the predetermined range from the position indicated by the position information.

3. The non-transitory computer-readable storage medium as claimed in claim 1, wherein the displaying displays an icon at the position on the screen of the display unit displaying the Web page, and displays the input information in the vicinity of the position in response to a trigger that is generated when the cursor overlaps the icon.

4. The non-transitory computer-readable storage medium as claimed in claim 1, wherein the storing stores a plurality of pairs of the position information and the input information with respect to the Web page.

5. The non-transitory computer-readable storage medium as claimed in claim 1, wherein the storing translates the input information from a first language in which the input information is written into a second language different from the first language and stores the input information in the second language into the file, in response to a trigger that is generated when the input information is input from the input device.

6. The non-transitory computer-readable storage medium as claimed in claim 1, wherein the storing stores, into the file, the input information including one or more local or remote links where information related to information displayed at the position on the Web site is stored.

7. The non-transitory computer-readable storage medium as claimed in claim 1, wherein the storing stores the file in the storage unit in order to be accessible from outside the computer.

8. The non-transitory computer-readable storage medium as claimed in claim 1, wherein the input information input from the input device includes contents displayed in a vicinity of the position on the Web page and input by a copy-and-paste operation of the input device.

9. The non-transitory computer-readable storage medium as claimed in claim 1, wherein the input information input from the input device is written in a description language not dependent from a description language of the Web page.

10. The non-transitory computer-readable storage medium as claimed in claim 1, wherein the process further comprises:
making access to the Web page specified from the input device and displaying the Web page on the screen of the display unit.

11. An information processing apparatus comprising:
a display unit configured to display on a screen thereof a Web page that is being browsed;
an input device configured to receive position information indicating a specified position on the Web page, and input of input information to be added with respect to the position;
a storage unit configured to store the position information and the input information in a file with respect to the Web page; and
a control unit configured to display the input information stored in the file on the screen in a vicinity of the specified position when a cursor on the screen of the display unit displaying the Web page enters a predetermined range from the specified position indicated by the position information.

12. The information processing apparatus as claimed in claim 11, wherein the control unit makes a popup display in which the input information is displayed, in the vicinity of the position on the screen of the display unit displaying the Web page, in response to a trigger that is generated when the cursor enters the predetermined range from the position indicated by the position information.

13. The information processing apparatus as claimed in claim 11, wherein the control unit displays an icon at the position on the screen of the display unit displaying the Web page, and displays the input information in the vicinity of the position in response to a trigger that is generated when the cursor overlaps the icon.

14. The information processing apparatus as claimed in claim 11, wherein the control unit includes a translator configured to translate the input information from a first language in which the input information is written into a second language different from the first language and stores the input information in the second language into the file, in response to a trigger that is generated when the input information is input from the input device.

15. The information processing apparatus as claimed in claim 11, wherein the input information stored in the file includes one or more local or remote links where information related to information displayed at the position on the Web site is stored.

16. The information processing apparatus as claimed in claim 11, wherein the storage unit stores the file in a manner accessible from outside the information processing apparatus.

17. A method to add information in a referable manner with respect to contents of a browsing Web page, the method comprising:
storing, by a computer, into a file of a storage unit, position information indicating a position on a Web page that is being displayed on a screen of a display unit and specified from an input device, and input information to be added with respect to the position and input from the input device, with respect to the Web page; and
displaying, by the computer, the input information stored in the file on the screen in a vicinity of the position when a cursor on the screen of the display unit displaying the Web page enters a predetermined range from the position indicated by the position information.

18. The method as claimed in claim 17, wherein the displaying makes a popup display in which the input information is displayed, in the vicinity of the position on the screen of the display unit displaying the Web page, in response to a trigger that is generated when the cursor enters the predetermined range from the position indicated by the position information.

19. The method as claimed in claim 17, wherein the displaying displays an icon at the position on the screen of the display unit displaying the Web page, and displays the input information in the vicinity of the position in response to a trigger that is generated when the cursor overlaps the icon.

20. The method as claimed in claim 17, wherein the storing translates the input information from a first language in which the input information is written into a second language different from the first language and stores the input information in the second language into the file, in response to a trigger that is generated when the input information is input from the input device.
